(19) United States
(12) Patent Application Publication
(10) Pub. No.: US 2021/0272073 A1
(43) Pub. Date: Sep. 2, 2021

(54) GARBAGE SORTING AND RECYCLIING METHOD, SYSTEM, AND COMPUTER READABLE STORAGE MEDIUM

(71) Applicant: TRIPLE WIN TECHNOLOGY(SHENZHEN) CO.LTD., Shenzhen (CN)

(72) Inventor: JIN-KE CHEN, Jincheng (CN)

(21) Appl. No.: 16/853,979

(22) Filed: Apr. 21, 2020

(30) Foreign Application Priority Data
Feb. 28, 2020 (CN) 202010131482.X

(51) Int. Cl. G06Q 10/00; B07C 5/342; B07C 7/00; G06Q 50/26; G06N 20/00; G06N 5/04; G05B 19/4155; G06K 9/62; G06K 9/00; G10L 17/06

(52) U.S. Cl. CPC G06Q 10/30; G05B 2219/45047; B07C 7/005; G06Q 50/26; G06N 20/00; G06N 5/04; G05B 19/4155; G06K 9/628; G06K 9/627; G06K 9/6217; G06K 9/6201; G06K 9/00362; G10L 17/06; B07C 2501/0054; G05B 2219/40034; B07C 5/3422

(57) ABSTRACT

A method for sorting and recycling garbage recycles garbage of certain types into a garbage collecting device, the garbage recycling device implements the method and includes a temporary storage box and a storage box having an inlet. The method acquires an image of garbage in the temporary storage box, analyzes the image to obtain a first classification information and determines whether the first classification information matches a recycling category. The inlet of the storage box is opened when the first classification information matches a certain recycling category. A garbage sorting and recycling system and a computer readable storage medium are also provided.

### FIELD

The disclosure generally relates to a garbage sorting and recycling method.

### BACKGROUND

When disposing of garbage, people do not have time to accurately identify the type of garbage, or will randomly throw all garbage. The intended type of garbage may be marked on garbage bins, but ordinary garbage bins can only passively store garbage, they do not help people to accurately sort the garbage.

### BRIEF DESCRIPTION OF THE DRAWINGS

Implementations of the present technology will now be described, by way of embodiments, with reference to the attached figures.

FIG. 1 is a schematic diagram illustrating an embodiment of a garbage sorting and recycling system.

FIG. 2 is a schematic view of an embodiment of a control device for sorting garbage.

FIG. 3 is a block diagram illustrating an embodiment of a garbage sorting and recycling procedure.

FIG. 4 is a flow chart of a first embodiment of a method for garbage sorting and recycling.

FIG. 5 is a flow chart of a second embodiment of a method for garbage sorting and recycling.

FIG. 6 is a flow chart of step process in acquiring a second sorting information in the method shown in FIG. 5.

FIG. 7 is a flow chart of a third embodiment of a method for garbage sorting and recycling.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

The term “comprising” means “including, but not necessarily limited to”, it specifically indicates open-ended inclusion or membership in a so-described combination, group, series, and the like.

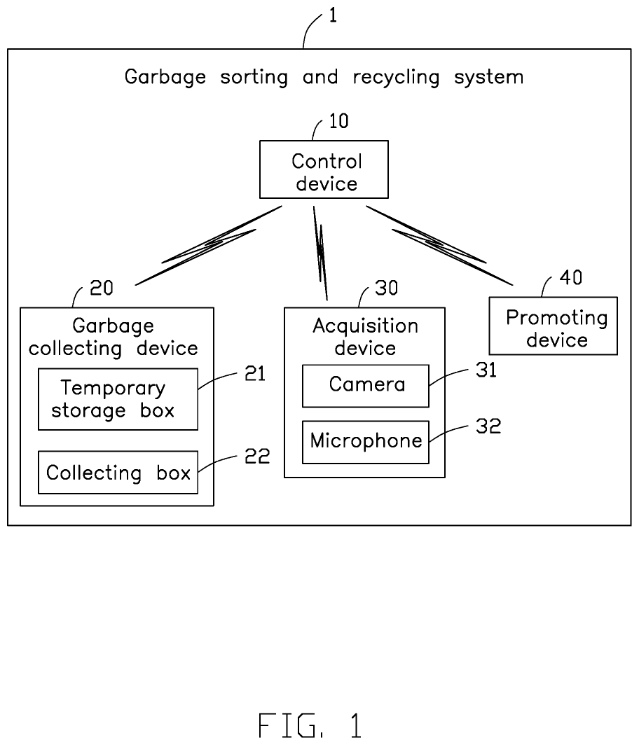

FIG. 1 illustrates an embodiment of a garbage sorting and recycling system 1. The garbage sorting and recycling system 1 can include a control device 10, a garbage collecting device 20, an acquisition device 30, and a prompting device 40. The control device is connected to the garbage collecting device 20, the acquisition device 30, and the prompting device 40.

The number of garbage collecting devices 20 may be one or more. The garbage collecting device 20 includes a temporary storage box 21 and a collecting box 22 connected to the temporary storage box 21. The temporary storage box 21 is used for temporarily storing garbage, and the collecting box 22 may be located below the temporary storage box 21 and used for collecting garbage to be recycled. The temporary storage box 21 is provided with a feeding port, and the collecting box 22 is provided with an inlet. The garbage collecting device 20 may further include a driving member such as a motor for controlling the feeding port of the temporary storage box 21 and the inlet of the collecting box 22. It can be understood that one temporary storage box 21 may be connected to one or more collecting boxes 22.

The acquisition device 30 is configured to collect images and voice information. In one embodiment, the acquisition device 30 includes a camera 31 and a microphone 32. In other embodiments, the acquisition device 30 may include either the camera 31 or the microphone 32.

In one embodiment, the acquisition device 30 is further configured to collect commands and information for sorting garbage (“sort information”), and the sort information includes at least one of an initial image of garbage to be classified and user voice information. The acquisition device 30 is further configured to collect a detection image of the garbage in the temporary storage box 21.

The prompting device 40 is configured to issue a voice prompt or an image prompt. The prompting device 40 may include at least one of a display screen and a speaker.

The acquisition device 30 and the prompting device 40 can be installed on or adjacent to the garbage collecting device 20. It can be understood that the prompting device 40 may be omitted.

The control device 10 may be installed in the garbage collecting device 20 as a controller of the garbage collecting device 20. The control device 10 may also be a computer or a mobile terminal disposed in a user's home, or a cloud server.

The number of the control devices 10 may be one or more. For example, the control device 10 may be installed on the garbage collecting device 20 and the cloud server at the same time. The control device 10 installed on the garbage collecting device 20 obtains sort information through the acquisition device 30, and sends the obtained sort information to the cloud server for processing and then receives information processed by the cloud server to control the garbage collecting device 20 and the prompting device 40.

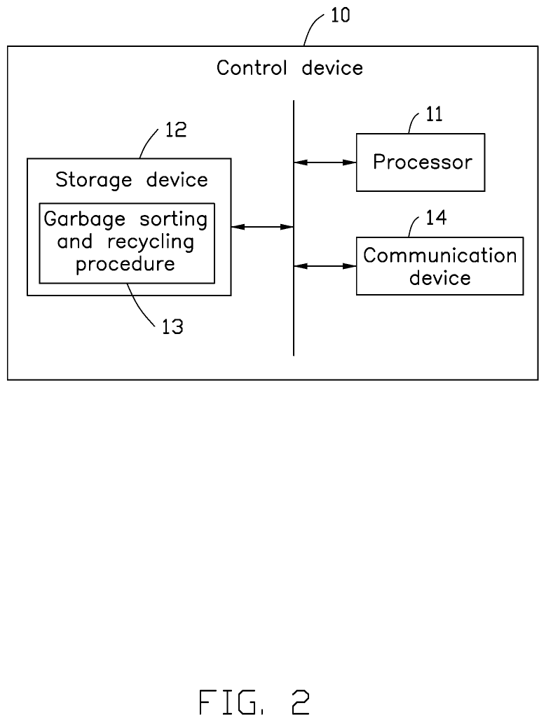

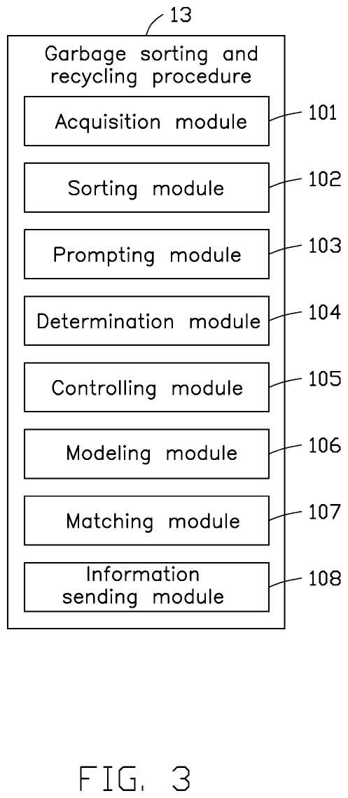

FIG. 2 illustrates a control device 10 of an embodiment. The control device 10 may include a processor 11, a storage device 12, and a garbage sorting and recycling procedure 13 stored in the storage device 12 and executable on the processor 11. When the processor 11 executes the garbage sorting and recycling procedure 13, the steps in the embodiment of the garbage sorting and recycling method are implemented. Alternatively, when the processor 11 executes the garbage sorting and recycling procedure 13, the functions of the modules in the embodiment of the garbage sorting and recycling procedure 13 are implemented, for example, modules 101 to 108 as in FIG. 3.

The processor 11 may include one or more central processors (CPUs), a microprocessor, a digital processing chip, a graphics processor, or a combination of various control chips. The processor 11 may use various interfaces and communication buses to connect various parts of the control device 10.

The storage device 12 stores various types of data in the control device 10, such as program codes and the like. The storage device 12 can be, but is not limited to, read-only memory (ROM), random-access memory (RAM), programmable read-only memory (PROM), erasable programmable ROM (EPROM), one-time programmable read-only memory (OTPROM), electrically EPROM (EEPROM), compact disc read-only memory (CD-ROM), hard disk, solid-state drive, or other forms of electronic, electromagnetic, or optical recording medium.

In one embodiment, the control device 10 may further include a communicating device 14, and the communicating device 14 can communicate with other computing devices wirelessly or by wires.

Other examples of the control device 10 may include more or fewer components than those illustrated, or combine some other components, or be otherwise different. For example, the control device 100 may also include network access devices, buses, and the like.

FIG. 3 shows the garbage sorting and recycling procedure 13 running in the control device 10. The garbage sorting and recycling procedure 13 may include an acquisition module 101, a sorting module 102, a prompting module 103, a determination module 104, a controlling module 105, a modeling module 106, a matching module 107, and an information sending module 108. In one embodiment, the above modules may be programmable software instructions stored in the storage device 12, callable by the processor 11 for execution. It can be understood that, in other embodiments, the above modules may also be program instructions or firmware fixed in the processor 11.

The acquisition module 101 acquires sort information for sorting garbage, through the acquisition device 30. The sort information includes at least one of the initial images of garbage and user voice information.

The acquisition module 101 further acquires an image of the garbage in the temporary storage box 21 of the garbage collecting device 20, through the acquisition device 30.

The acquisition module 101 further acquires an image of user through the acquisition device 30.

The sorting module 102 analyzes the image or images to obtain a first classification information of the garbage.

The sorting module 102 further analyzes the sort information for sorting garbage to obtain a second classification information of the garbage.

The prompting module 103 is configured to send a prompting information and an alarm information, and the prompting information includes the second classification information of the garbage.

The determination module 104 determines whether the first classification information matches the recycling category of the garbage collecting device 20.

The controlling module 105 controls the collecting box 22 of the garbage collecting device 20 to open so that the collecting box 22 receives the garbage. In one embodiment, the controlling module 105 further controls the temporary storage box 21 of the garbage collection device 20 to open.

The modeling module 106 establishes a classification model, and the classification model is used to analyze the category of the garbage according to the image. The classification model may be a deep learning neural network model, such as a convolutional neural network model.

The matching module 107 matches the image of user with a preset user database to obtain an identity of the user.

The information sending module 108 sends the user's identity and the current garbage placement information to a credit system.

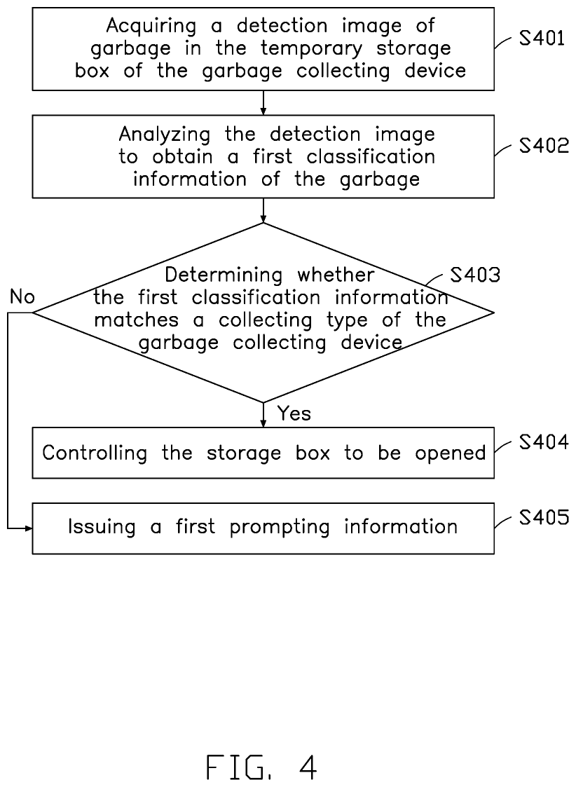

A method for sorting and recycling garbage of a first embodiment is illustrated in FIG. 4. The method is provided by way of embodiments, as there are a variety of ways to carry out the method. Each block shown in FIG. 4 represents one or more processes, methods, or subroutines carried out in the example method. Additionally, the illustrated order of blocks is by example only and the order of the blocks can be changed. The method can begin at block S401.

At block S401, an image of garbage in the temporary storage box 21 of the garbage collecting device 20 is acquired.

After the user puts the garbage in the temporary storage box 21 of the garbage collecting device 20, the control device 10 can acquire the image of the garbage through the acquisition device 30.

At block S402, the image is analyzed to obtain a first classification information of the garbage.

The control device 10 can input the image into a preset classification model to obtain the first classification information of the garbage. The classification model may be a deep learning neural network model, such as a convolutional neural network model.

At block S403, it is determined whether the first classification information from the image matches the recycling category of the garbage collecting device 20.

If yes, the process proceeds to block S404; if no, the process proceeds to block S405.

At block S404, the collecting box 22 is controlled to be opened, so that the collecting box 22 receives the garbage.

In one embodiment, the control device 10 can control the inlet of the collecting box 22 to open, and the garbage can move or drop into the collecting box 22 from the temporary storage box 21.

At block S405, a first prompting information is issued.

If the first classification information does not match the recycling category of the garbage collecting device 20, the inlet of the collecting box 22 is not opened, and the first prompting information is issued. The first prompt information may include at least one of the first classification information of the garbage, a warning information indicating that the category is error, and a prompt information indicating that the garbage needs to be disposed of in different manner. The first prompt information may be sent through voice reminders, image reminders, short message reminders, APP notifications, and the like.

For example, the first prompt information includes the first classification information, so that the user understands the correct classification of garbage. The first prompt information may also include the warning information, and the user is requested to confirm whether the category of the garbage and the recycling category of the garbage collecting device 20 are the same, to avoid errors of the system.

When the control device 10 is installed in the garbage collecting device 20, the prompting device 40 can be directly controlled to send the first prompting information.

When the control device 10 is a cloud server, the control device 10 may send the alarm information to the prompting device 40, so that the prompting device 40 issues the alarm information.

The above garbage sorting and recycling method can analyze the image of the garbage in the temporary storage box 21 to obtain the first classification information of the garbage, and determine whether the first classification information and the recycling category of the garbage collecting device 20 are consistent. In this case, the collecting box 22 is opened, so that the collecting box 22 can only store garbage of a certain category, to prevent misclassification. Therefore, the above method improves the accuracy of garbage classification, gradually guides people to understand the type of garbage, and enhances awareness of garbage classifications.

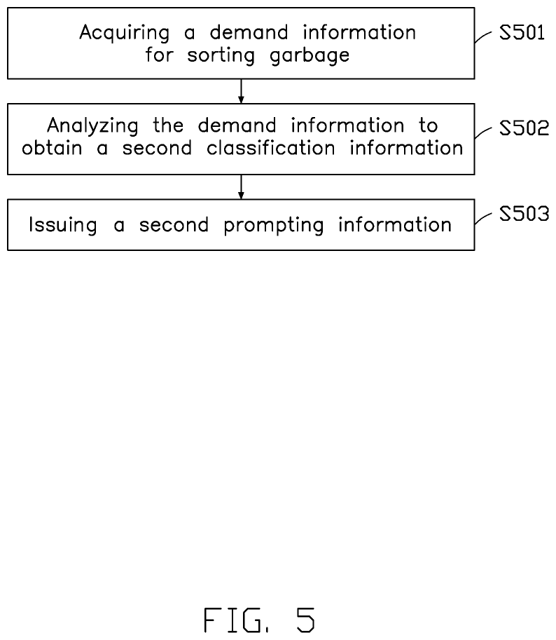

FIG. 5 illustrates a method for sorting and recycling garbage of a second embodiment. Before the step at block S401, the method further includes the following steps.

At block S501, a sort information for sorting garbage is acquired.

The sort information includes at least one of the initial images of garbage to be classified and user voice information.

The control device 10 may obtain the sort information through the garbage collecting device 20.

It can be understood that the garbage collecting device 20 may be equipped with a sensor. When the sensor senses that the user is approaching, the acquisition device 30 is automatically invoked. It can be understood that the acquisition device 30 may also receive a startup instruction to collect the sort information.

At block S502, the sort information is analyzed to obtain a second classification information.

The process at block S502 can be performed by the sorting module 102.

The second classification information of the garbage may be dry garbage, wet garbage, recyclable garbage, hazardous garbage, and the like.

When the sort information includes only the initial image or the voice information, the initial image or the voice information can be analyzed. When the sort information includes both the initial image and the voice information, the initial image and voice information can be analyzed separately, and the priority of the analysis is set to determine the second classification information. For example, it is set to preferentially obtain the second classification information of garbage according to the analysis of the voice information, as detailed later.

At block S503, a second prompting information is issued.

The second prompting information includes a second classification information of the garbage.

The control device 10 can control the prompting device 40 to issue the second prompting information, which can be a voice prompt or an image prompt, so that the user can know the category of garbage to be accepted.

In one embodiment, after the second prompting message is issued in step S503, the method further includes: controlling the temporary storage box 21 of the garbage collecting device 20 to open only if the second classification information is matching so that the temporary storage box 21 receives the garbage.

In one embodiment, the sort information may include only the initial image. At block S502, the initial image is input into a preset classification model to obtain the second classification information of the garbage. The classification model may be a deep learning neural network model.

The sort information may only include the user voice information. At block S502, the information of the garbage is extracted from the user voice information, and then matched with a preset garbage classification database to obtain the second classification information of garbage.

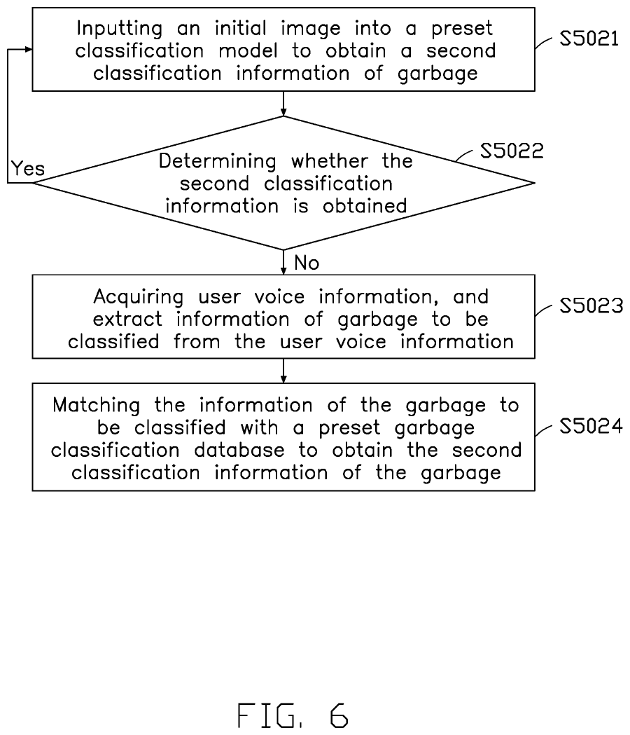

FIG. 6 illustrates one embodiment of the process at block S502.

At block S5021, an initial image is input into a preset classification model to obtain a second classification information of garbage.

At block S5022, it is determined whether the second classification information is obtained.

If yes, the process proceeds to block S503. If no, the process proceeds to block S5023.

At block S5023, a user voice information is acquired, and an information of the garbage is extracted from the user voice information.

At block S5024, the information of the garbage to be classified is matched with a preset garbage classification database to obtain the second classification information of the garbage.

The above method can analyze the sort information to obtain the second classification information of the garbage, and issue the second prompt information according to the second classification information, so that the user can clearly understand the category of acceptable garbage, and prevent wrong classification.

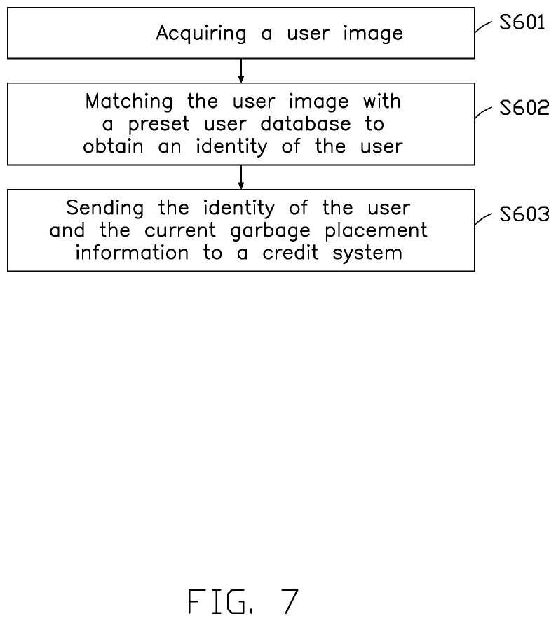

FIG. 7 illustrates a garbage sorting and recycling method of a third embodiment. After the process of the block S501, the method further includes the following steps.

At block S601, a user image is acquired.

At block S602, the user image is matched with a preset user database to obtain an identity of the user.

At block S603, the identity of the user and the garbage placement information are sent to a credit system.

If the garbage which is delivered is correct in category, the garbage placement information is recorded normally; if there is an alarm information, the garbage placement information is recorded as abnormal. After the user's identity and garbage placement information are recorded in the credit system, the user can be urged to manage his credit and raise the awareness of garbage classification. Furthermore, the user's willingness for garbage classification can be enhanced through commercial rewards.

The above control device 10, method and computer-readable storage medium can improve the accuracy rate of garbage classification, cultivate users' awareness and cognition of garbage classification, and improve the use of resources.

A person skilled in the art can understand that all or part of the processes in the above embodiments can be implemented by a computer program to instruct related hardware, and that the program can be stored in a computer readable storage medium. When the program is executed, a flow of steps of the methods as described above may be included.

In addition, each functional device in each embodiment may be integrated in one processor, or each device may exist physically separately, or two or more devices may be integrated in one device. The above integrated device can be implemented in the form of hardware or in the form of hardware plus software function modules.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being embodiments of the present disclosure.

What is claimed is:

1. A garbage sorting and recycling method configured for recycling garbage into a garbage collecting device, wherein the garbage recycling device comprises a temporary storage box and a collecting box connected to the temporary storage box, the collecting box comprises an inlet, the method comprising:
acquiring an image of garbage in the temporary storage box of the garbage collecting device;
analyzing the image to obtain a first classification information of the garbage;
determining whether the first classification information matches a recycling category of the garbage collecting device; and
controlling the inlet of the temporary storage box to be opened, when the first classification information matches the recycling category of the garbage collecting device.

2. The garbage sorting and recycling method of claim 1, further comprising:
issuing a first prompting information, when the first classification information does not match the recycling category of the garbage collecting device.

3. The garbage sorting and recycling method of claim 1, wherein before acquiring an image of garbage in the temporary storage box of the garbage collecting device, the method further comprising:
acquiring commands and a sort information for sorting garbage;
analyzing the sort information to obtain a second classification information; and
issuing a second prompting information.

4. The garbage sorting and recycling method of claim 3, wherein the demand information comprises an initial image of garbage to be classified and user voice information, the step of analyzing the sort information to obtain a second classification information comprises:
inputting an initial image into a preset classification model to obtain a second classification information of garbage, the classification model being a deep learning neural network model;
determining whether the second classification information is obtained;
acquiring user voice information, and extract information of garbage from the user voice information;
matching the information of garbage with a preset garbage classification database to obtain the second classification information of the garbage.

5. The garbage sorting and recycling method of claim 3, wherein the demand information comprises an initial image of garbage to be classified, and the step of analyzing the sort information to obtain a second classification information comprises:
inputting an initial image into a preset classification model to obtain a second classification information of garbage, the classification model being a deep learning neural network model.

6. The garbage sorting and recycling method of claim 3, wherein the sort information comprises user voice information, and the step of analyzing the sort information to obtain a second classification information comprises:
extracting information of garbage of the user voice information;
matching the information of garbage with a preset garbage classification database to obtain the second classification information of the garbage.

7. The garbage sorting and recycling method of claim 3, wherein after issuing the second prompting information, the method further comprising:
controlling the temporary storage box corresponding to the second prompting information to be opened.

8. The garbage sorting and recycling method of claim 3, further comprising:
acquiring a user image;
matching the user image with a preset user database to obtain an identity of the user; and
sending the identity of the user and a garbage placement information to a credit system.

9. A garbage sorting and recycling system, comprising:
a garbage collecting device comprising a temporary storage box and a collecting box connected to the temporary storage box, the collecting box having an inlet;
an acquisition device configured to acquire an image of garbage in the temporary storage box; and
a control device communicating with the garbage collecting device and the acquisition device, the control device comprising:
at least one processor; and
at least one storage device storing one or more programs, when executed by the processor, the one or more programs cause the processor to:
acquire an image of garbage in the temporary storage box of the garbage collecting device;
analyze the image to obtain a first classification information of the garbage;
determine whether the first classification information matches a recycling category of the garbage collecting device; and
control the inlet of the temporary storage box to be opened, when the first classification information matches the recycling category of the garbage collecting device.

10. The garbage sorting and recycling system of claim 9, wherein the one or more programs further cause the processor to:
issue a first prompting information, when the first classification information does not match the recycling category of the garbage collecting device.

11. The garbage sorting and recycling system of claim 9, wherein the one or more programs further cause the processor to:
acquire commands and a sort information for sorting garbage before acquiring an image of garbage;
analyze the sort information to obtain a second classification information; and
issue a second prompting information.

12. The garbage sorting and recycling system of claim 11, wherein the sort information comprises an initial image of garbage to be classified and user voice information, the step of analyze the sort information to obtain a second classification information comprises:
inputting an initial image into a preset classification model to obtain a second classification information of garbage, the classification model being a deep learning neural network model;
determining whether the second classification information is obtained;
acquiring user voice information, and extract information of garbage from the user voice information;
matching the information of garbage with a preset garbage classification database to obtain the second classification information of the garbage.

13. The garbage sorting and recycling system of claim 11, wherein the one or more programs further cause the processor to:
control the temporary storage box corresponding to the second prompting information to be opened.

14. The garbage sorting and recycling system of claim 11, wherein the one or more programs further cause the processor to:
acquire a user image;
match the user image with a preset user database to obtain an identity of the user; and
send the identity of the user and a garbage placement information to a credit system.

15. A computer readable storage medium having stored thereon instructions that, when executed by at least one processor of a computing device, causes the processor to perform a garbage sorting and recycling method, wherein the method comprises:
acquiring an image of garbage in the temporary storage box of the garbage collecting device;
analyzing the image to obtain a first classification information of the garbage;
determining whether the first classification information matches the recycling category of the garbage collecting device; and
controlling the inlet of the storage box to be opened, when the first classification information matches the recycling category of the garbage collecting device.

16. The computer readable storage medium of claim 15, the method further comprising:
issuing a first prompting information, when the first classification information does not match the recycling category of the garbage collecting device.

17. The computer readable storage medium of claim 15, before acquiring an image of garbage in the temporary storage box of the garbage collecting device, the method further comprising:
acquiring commands and a sort information for sorting garbage;
analyzing the sort information to obtain a second classification information; and
issuing a second prompting information.

18. The computer readable storage medium of claim 17, the sort information comprises an initial image of garbage to be classified and user voice information, the step of analyzing the sort information to obtain a second classification information comprises:
inputting an initial image into a preset classification model to obtain a second classification information of garbage, the classification model being a deep learning neural network model;
determining whether the second classification information is obtained;
acquiring user voice information, and extract information of garbage of the user voice information;
matching the information of garbage with a preset garbage classification database to obtain the second classification information of the garbage.

19. The computer readable storage medium of claim 17, wherein after issuing the second prompting information, the method further comprising:
controlling the temporary storage box corresponding to the second prompting information to be opened.

20. The computer readable storage medium of claim 17, further comprising:
acquiring a user image;
matching the user image with a preset user database to obtain an identity information of the user; and
sending the identity information of the user and a garbage placement information to a credit system.
